(19) United States
(12) Patent Application Publication
(10) Pub. No.: US 2005/0069287 A1
(43) Pub. Date: Mar. 31, 2005

(54) Private video recorder for implementing passive highlight function and method for providing highlight information to the same

(76) Inventor: Jong-Yeul Suh, Seoul (KR)

Correspondence Address: BIRCH STEWART KOLASCH & BIRCH, PO BOX 747, FALLS CHURCH, VA, 22040-0747, US

(21) Appl. No.: 10/950,598

(22) Filed: Sep. 28, 2004

(30) Foreign Application Priority Data
Sep. 30, 2003 (KR) 10-2003-0067940

(51) Int. Cl. H04N 5/76; H04N 5/781

(52) U.S. Cl. 386/46; 386/125

(57) ABSTRACT

A personal video recorder with a passive highlight function is provided. In the recorder, a stream demultiplexer separates a received broadcast stream including highlight information into video, audio, data, and highlight information streams, and transfers the separated streams to respective decoder blocks capable of decoding the separated streams. A storage unit stores the received broadcast stream, a download controller stores the received broadcast stream in the storage unit, and an upload controller reproduces the broadcast stream stored in it. A playback controller accurately locates and reads highlight data to be reproduced from the broadcast stream and controls playback speed of the highlight data using the highlight information stream. A method for providing highlight information to the personal video recorder is also provided, in which highlight information of a broadcast program is generated, the highlight information is combined with a broadcast stream to be transmitted, and the broadcast stream combined therewith is transmitted.

### BACKGROUND OF THE INVENTION

1. Field of the Invention

The present invention relates to a method for providing information required to generate and reproduce a highlight information stream of a program recorded in a personal digital video recorder, and more particularly to a method for providing highlight information of a program recorded on a hard disk or other storage units, which includes fields indicative of key scenes of the program and indicative of playback modes of the key scenes and which is produced by a broadcast station or a third-party service provider, in real-time or in non-real time to the user through a medium such as a dedicated line or through terrestrial, cable or satellite broadcasting, and a personal video recorder suitable for using the method.

2. Description of the Related Art

The personal video recorder is a device capable of recording digital broadcasts on a hard disk. The personal video recorder supports not only recording, as a main function, but also time shifting, instant replay of a live broadcast program and other various trick plays so that the user can enjoy the digital TV in various ways.

The most important feature of the personal video recorder is to allow the user to store and view digital broadcasts with the highest HD-level image quality at any time. The trick play or other various additional service functions provided by the personal video recorder enable the user to utilize a recorded program or a live program in various ways.

A highlight or summary function, one of the various additional functions, enables the user to view a large amount of recorded programs or access a desired part thereof easily and rapidly for a limited time. It is necessary for the personal video recorder to be equipped with such a highlight function to enable the user to review a number of programs recorded in the recorder all at once in a short time. Implementation of the highlight function requires an effective method for condensing (i.e., summarizing) the entirety of a program so that the user can get the gist of the program in a short time.

The highlight function uses part of the data of a recorded program to represent the entirety of the program, so as to provide condensed information of the program to the user. “Highlights” refer to a specific set of segments (i.e., a specific set of scenes) of the program, which are reproduced in an appropriate manner separately from the program. For example, when the user desires to select and view a desired program from among a number of programs stored in the personal video recorder for a limited time, the user reproduces only the highlight stream of each program, thereby reducing the time required to get the gist of the desired program.

The highlight function is useful particularly in compressing the scenes of a broadcast program such as a sports broadcast program into a brief video clip. For example, the highlight function produces a brief video by selectively collecting only decisive and key scenes such as scoring scenes, and provides the produced brief video to the user.

The conventional method for implementing the highlight function extracts highlights from a program recorded in the personal video recorder by analyzing video and audio data of the recorded program. This conventional method has limitations due to the characteristics of the post-recording processing, failing to automatically generate highlights of a level meeting users' demands.

A large amount of calculation must also be performed to extract the highlights, which causes a significant load on the hardware and software. To provide an effective highlight function for a program, the program must be divided into segments (i.e., scenes) that are individually meaningful in terms of the content, and the importance of each of the divided scenes must be measured to select scenes representative of the program. In other words, to implement an effective highlight function for video data, the video data must be divided into segments corresponding to scenes that are distinguished from each other in terms of content, and quantitative measurement must also be performed to measure the importance of each of the divided segments to select key scenes.

Implementation of the conventional highlight function requires a very complicated and sophisticated algorithm, and also significantly increases the complexity of hardware and software required to manufacture the personal video recorder. The increased complexity results in an increase in the price of the personal video recorder, thereby increasing the price burden on the user.

Items used when practically producing highlights of a program, such as criteria for determining scene change, the appropriate number of highlight scenes, and connection of scenes, which are associated with each other in terms of content, vary significantly depending on the genre of the program. The conventional method has insufficient quantitative basis for determination of these items, which causes significant vagueness in the highlights when practically implementing the highlight function. Since the conventional algorithm produces highlights of a program on the basis of video and audio signals of the program, it is substantially impossible for the algorithm to effectively identify the scenes in terms of their contents no matter how sophisticated the algorithm is, resulting in failure to guarantee the reliability of the highlights.

The performance of the conventional highlight function based on the post-recording processing is not satisfactory compared to the price and complexity required for the implementation of the highlight function.

### SUMMARY OF THE INVENTION

Therefore, the present invention has been made in view of the above problems, and it is an object of the present invention to provide a personal video recorder for receiving and storing highlight information of a previously recorded program in a broadcast service environment, and for using the highlight information to correctly reproduce corresponding highlights of the program as intended by a broadcast station or a third-party service provider.

It is another object of the present invention to provide a method for providing highlight information of a broadcast program, required to implement a highlight function thereof, to the user after producing highlights of the broadcast program by a broadcast station or a third-party service provider.

In accordance with one aspect of the present invention, the above and other objects can be accomplished by the provision of a personal video recorder for implementing a passive highlight function, the recorder comprising a stream demultiplexer for separating a received broadcast stream including highlight information into video, audio, data, and highlight information streams, and transferring the separated streams to corresponding decoder blocks capable of decoding the separated streams; storage means for storing the received broadcast stream; a download controller for storing the received broadcast stream in the storage means; an upload controller for reproducing the broadcast stream stored in the storage means; and a playback controller for accurately locating and extracting highlight data to be reproduced from the broadcast stream and controlling playback speed of the highlight data using the highlight information stream.

Preferably, the download controller stores the broadcast stream with a time stamp added thereto in the storage means.

Preferably, the highlight information stream includes a highlight ID code, information of the number of highlight scenes, highlight data location information, and highlight playback mode information.

Preferably, the highlight information stream further includes a program ID.

Preferably, the data stream includes broadcast schedule information.

Preferably, if a program corresponding to the highlight information stream is not present in the storage means, the download controller automatically avoids reception of the highlight information stream or automatically deletes the highlight information stream when the highlight information stream is received.

Preferably, the storage means employs a hard disk.

In accordance with another aspect of the present invention, there is provided a method for providing highlight information to a personal video recorder, comprising the steps of a) generating highlight information of a broadcast program; b) combining the highlight information with a broadcast stream to be transmitted; and c) transmitting the broadcast stream combined with the highlight information.

In accordance with yet another aspect of the present invention, there is provided a method for providing highlight information to a personal video recorder, comprising the steps of a) generating highlight information of a broadcast program; b) informing a user of the personal video recorder of presence of the generated highlight information; c) determining by the user whether to receive the highlight information; d) combining the highlight information with a broadcast stream to be transmitted; and e) transmitting the broadcast stream combined with the highlight information.

Preferably, the highlight information stream includes a highlight ID code, information of the number of highlight scenes, highlight data location information, and highlight playback mode information.

Preferably, the highlight information stream further includes a program ID.

Preferably, the broadcast stream includes broadcast schedule information.

Preferably, the highlight information is produced by a broadcast station providing the broadcast program or a third party.

Preferably, the highlight information is transmitted by combining the highlight information with the program or another program.

### BRIEF DESCRIPTION OF THE DRAWINGS

The above and other objects, features and other advantages of the present invention will be more clearly understood from the following detailed description taken in conjunction with the accompanying drawings, in which:

FIGS. 1a and 1b are conceptual diagrams of a method for providing a broadcasting service for implementing a passive highlight function according to an embodiment of the present invention;

FIG. 2 is an illustrative diagram of the configuration of a broadcast stream including highlight information provided in a broadcast service method according to an embodiment of the present invention;

FIGS. 3a and 3b are illustrative diagrams of the configuration of a highlight information stream provided in a broadcast service method according to an embodiment of the present invention;

FIG. 4 is a block diagram of the configuration of a personal video recorder for implementing a passive highlight function according to an embodiment of the present invention;

FIG. 5a is an illustrative diagram of the configuration of received highlight information according to an embodiment of the present invention; and

FIG. 5b is an illustrative diagram of a method for reproducing highlights using received highlight information according to an embodiment of the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may obscure the subject matter of the present invention.

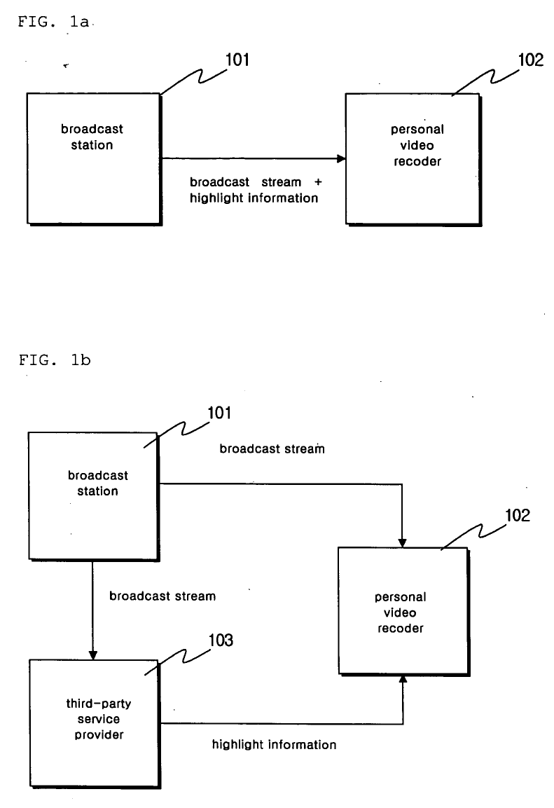

FIGS. 1a and 1b are conceptual diagrams of a method for providing a broadcasting service for implementing a passive highlight function according to an embodiment of the present invention. Highlight information is transmitted directly from a broadcast station in the method of FIG. 1a, whereas highlight information is transmitted from a third-party service provider in the method of FIG. 1b.

As shown in FIGS. 1a and 1b, highlight information is transmitted in the two main methods. In the highlight information transmission method of FIG. 1a, a broadcast station 101, which produces a broadcast program, creates highlights of the broadcast program used to efficiently represent main contents of the broadcast program in a short time according to characteristics thereof by genre. The broadcast station 101 then transmits basic metadata that enables a personal video recorder 102 of the user to properly and correctly reproduce the highlights. The broadcast station 101 can transmit the highlight information in real-time or non-real time.

In the real-time highlight information transmission, the highlight information is transmitted simultaneously with video, audio and data packets of the program. In the case where a previously produced program such as drama or movie is broadcast, previously created highlight information can be transmitted at the same time as when the program is broadcast. The real-time highlight information transmission indicates that video, audio, data, and highlight information packets of the same program are present in the same transport stream. On the other hand, the non-real time highlight information transmission is performed for a broadcast program such as a sports or live broadcast program in which highlight information cannot be transmitted simultaneously with the broadcasting, so that the highlight information is transmitted after the program is broadcast. In the non-real time highlight information transmission, the highlight information of the program can be transmitted to the user at a predetermined time (for example, about 1 hour) after the broadcasting is terminated.

In the highlight information transmission method of FIG. 1b, the third-party service provider 103, other than the broadcast station that produces the program, creates highlights of the program, and then transmits basic information, required to properly reproduce the highlights in the personal video recorder 102, to the user. The third-party service provider 103 is, for example, another broadcast station or a service provider specializing in providing highlight information.

Independent connection means such as a dedicated line is provided between the user and the service provider 103. The highlight information transmission method of FIG. 1b is classified as the non-real time highlight information transmission method. The personal video recorder 102 must be capable of properly reproducing highlights of a program, received from the broadcast station 101 and then recorded in the recorder 102, by linking the recorded program to corresponding highlight information provided from the third-party service provider 103.

Highlight information transmission is performed in two modes, i.e., unidirectional and bidirectional modes. In the unidirectional mode, the highlight information transmission is performed only to the personal video recorder 102, as with the transmission of the broadcast program from the broadcast station 101 or the third-party service provider 103 to the personal video recorder 102. In the unidirectional mode, the personal video recorder 102 may receive unnecessary highlight information.

“Unnecessary highlight information” refers to highlight information of a program not recorded in the personal video recorder 102. To prevent the reception of unnecessary highlight information, the personal video recorder 102 needs to have a function to identify previously recorded programs and then to automatically avoid reception of an unnecessary one of the highlight information streams transmitted from the broadcast station 101 or from the third-party service provider 103 or to automatically delete the unnecessary information if it is received.

The unidirectional mode cannot be used when the third party provides the highlight information as in FIG. 1b. This is because the third party must know which program the user has received and recorded. That is, the third party needs to receive basic information, required to provide the highlight information, from the user.

In the bidirectional mode, the highlight information is provided to the user when the user desires to receive it. In this mode, if highlights of a broadcast program have been completely produced, the highlight information provider transmits a signal informing the personal video recorder 102 of whether highlight information for the broadcast program is present. The personal video recorder 102 preferably includes means for using this signal to inform the user that highlights of the recorded program are ready. By displaying “Highlight Available” for a specific program in a list of recorded programs, the personal video recorder 102 can inform the user of the presence of the highlights of the specific program. The user can receive highlight information of the corresponding program by activating an appropriate function to download the highlight information. That is, in the bidirectional mode, the user determines whether to receive the highlight information, and the highlight information is transmitted to the user only when the user desires to receive it.

Thus, the highlight information can be transmitted in 5 ways since the broadcast station can transmit highlight information in real-time or non-real time and in the unidirectional or bidirectional mode, and the third party can transmit highlight information only in the non-real time and bidirectional mode.

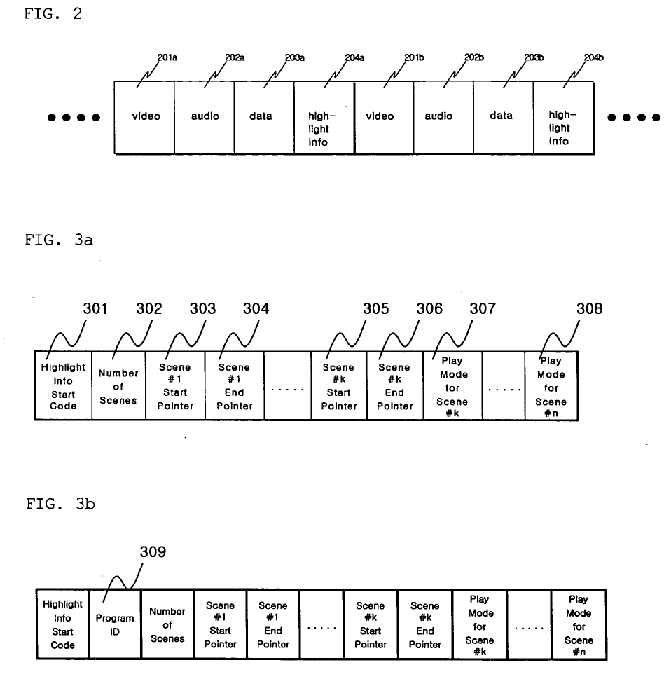

FIG. 2 is an illustrative diagram of the configuration of a broadcast stream for providing highlight information according to an embodiment of the present invention.

In this embodiment, a broadcast or transport stream includes video Elementary Streams (ESs) 201a and 201b, audio ESs 202a and 202b, and data ESs 203a and 203b, and further includes ESs 204a and 204b carrying the highlight information.

In FIG. 2, a PID must be assigned to each of the highlight information stream packets 204a and 204b in the broadcast stream, so that a system decoder in the broadcast receiver can parse the highlight information stream. In another embodiment, the highlight information is preferably carried within user data of a video stream. In another embodiment, the highlight information is preferably carried within a data stream.

In the case of the non-real time and unidirectional highlight information transmission, if the personal video recorder is turned off after recording a program, the recorder may fail to receive highlight information of the recorded program, which is provided from the broadcast station at a later time. Accordingly, the data stream preferably includes broadcast schedule information.

In the case of the non-real time highlight information transmission, a data stream of a currently received broadcast program preferably includes information about the time when highlight information of the broadcast program is to be transmitted. Using this highlight information transmission time information, the personal video recorder performs a programmed recording function to record only a highlight information stream of the program recorded in the recorder at a highlight information transmission time as set in the time information. By performing the programmed recording function, the personal video recorder receives the highlight information of the recorded program at the highlight information transmission time, so that the recorder can perform the highlight function when reproducing the recorded program at a later time.

In the case where the third party provides the highlight information to the user, there is no need to incorporate the broadcast schedule information into the data stream in the broadcast stream since the highlight information is automatically transmitted to the user at the request of the user.

FIGS. 3a and 3b are illustrative diagrams of the configuration of highlight information for real-time transmission (FIG. 3a) and highlight information for non-real time transmission (FIG. 3b) according to an embodiment of the present invention.

In this embodiment, fields of the highlight information differ slightly depending on whether the highlight information is for real-time transmission or for non-real time transmission.

As shown in FIG. 3, the highlight information of a program mainly includes highlight segment location information fields 303 to 306 indicating locations of segments of the program corresponding to key scenes thereof, and play mode fields 307 and 308 of the segments. As described above, in the real-time highlight information transmission, highlight information and stream data of the same program are transmitted within the same broadcast stream to the user in the same duration. That is, highlight information and stream data of the same program are received at the same time. On the other hand, in the non-real time transmission, since highlight information and stream data of the same program are received at different times, it is necessary to indicate which program currently-received highlight information corresponds to.

As shown in FIG. 3a, the highlight information for real-time transmission includes a Highlight Info Start Code field 301 indicating the start of the highlight information, a Number of Scenes field 302 indicating the number of scenes to be reproduced as highlights from among all scenes of the program, Scene #1-#n Start/End Pointer fields 303 to 306 indicating respective starts and ends of the scenes #1-#n, and Play Mode for Scene #1-#n fields 307 and 308 indicating respective play modes for the scenes #1-#n.

In the case of the non-real time highlight information transmission, the highlight information further includes a program ID field 309 to associate the highlight information with a corresponding program recorded in the personal video recorder.

The Number of Scenes field 302 allows the personal video recorder to previously know the number of scenes to be reproduced when reproducing the highlights. The Number of Scenes field 302 makes it easy to discriminate between the Scene #n Start/End Pointer fields 303 to 306 of the scenes #1-#n and the Play Mode for Scene #n fields 307 and 308 of the scenes #1-#n. Since the highlight information can be divided and transmitted in a number of transport packets, the previous knowledge of the number of scenes makes it easy to discriminate between the Scene #n Start/End Pointer fields 303 to 306 and the Play Mode for Scene #n fields 307 and 308.

The Scene #1 to #n Start/End Pointer fields 303 to 306 indicate the locations of data corresponding to the starts of the scenes #1 to #n and the locations of data corresponding to the ends thereof. For example, in one embodiment, the Scene #n Start/End Pointer fields 305 and 306 of the scene #n of a program indicate the respective ordinal numbers of two packets, which include the start and end of the scene #n, of all transport stream packets of the program. In another embodiment, the Scene #n Start/End Pointer fields 305 and 306 of the scene #n of a program indicate the respective ordinal numbers of two frames, which include the start and end of the scene #n, of all video data frames of the program.

In an embodiment of the present invention, the Play Mode for Scene #1 to #n fields 307 and 308 indicate the respective playback speeds of the scenes #1 to #n. High playback speeds such as double (2×) and triple (3×) but also low playback speeds such as half (½×) and quarter (¼×) are supportable in the present invention. In addition to the playback speed information, the Play Mode for Scene #1 to #n fields 307 and 308 may include information about various methods for effectively representing the scenes #1 to #4 according to the field of application.

The highlights of a program are reproduced by accurately locating and accessing data of the scenes #1 to #n in the program with reference to the Scene #1 to #n Start and End Pointer fields of the highlight information and by determining play modes (for example, playback speeds) for the scenes #1 to #n with reference to the Play Mode for Scene #1 to #n fields.

In the present invention, instead of inserting the Number of Scenes field into the highlight information, the personal video recorder may previously calculate the number of scenes to be reproduced as highlights in the following manner. Respective ID codes of the Start/End Pointer fields and the Play Mode fields are created and inserted before the Start/End Pointer fields and the Play Mode fields, so that the personal video recorder can previously calculate the number of scenes to be reproduced as highlights, based on the size of the highlights or the like.

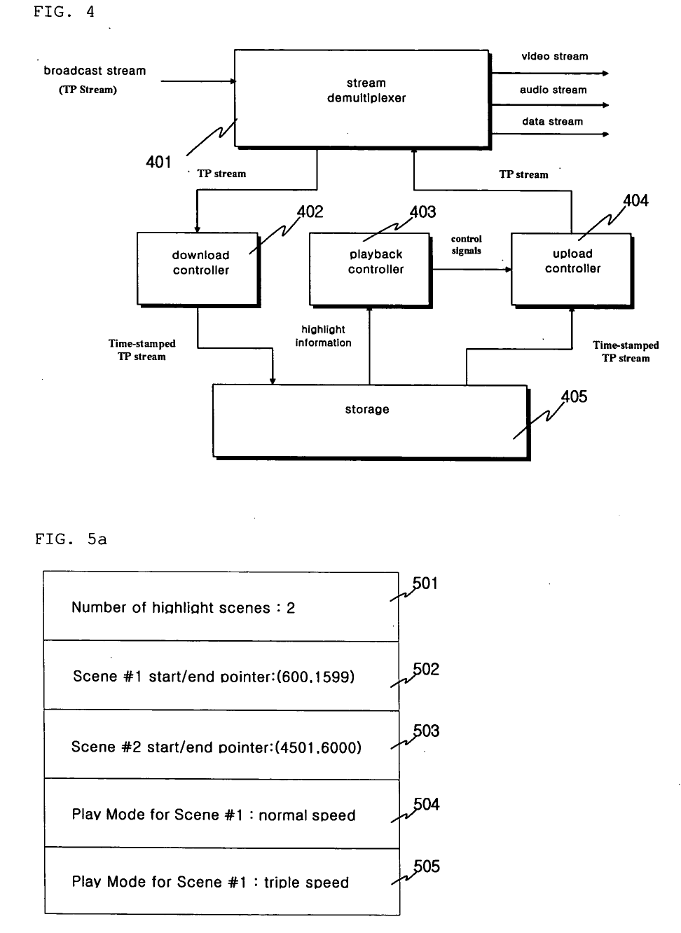

FIG. 4 is a block diagram of a personal video recorder for implementing a passive highlight function according to an embodiment of the present invention.

In this embodiment, the personal video recorder primarily includes a stream demultiplexer 401, a hard disk download controller 402, a playback controller 403, a hard disk upload controller 404, and a storage unit 405, as shown in FIG. 4.

The stream demultiplexer 401 separates an input transport stream into video, audio, data, and highlight information streams, and transfers the separated streams to corresponding decoder blocks capable of decoding them. The personal video recorder 102 stores the received broadcast stream with a “time stamp” header added to the existing transport packets.

The download controller 402 performs a function to record a broadcast in the storage unit 405 (a hard disk in this example). The upload controller 404 performs a function required for the system decoder to read the broadcast data from the storage unit 405 when the recorded broadcast data is reproduced. Here, the time stamp is used to control the speed of reading the broadcast data.

The playback controller 403 functions to accurately locate and read highlight data to be reproduced using the highlight information and to control the playback speed of the data using the highlight information. Although the storage unit 405 may be embodied in various forms, a hard disk is preferably used for the storage unit 405 in the present invention.

A detailed description of the operation of the personal video recorder will be given in the following embodiment.

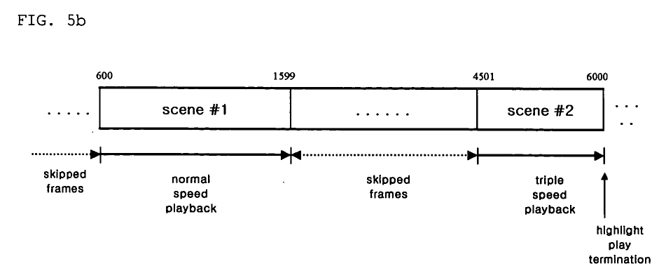

FIGS. 5a and 5b are diagrams illustrating how a personal video recorder performs a passive highlight function using received highlight information according to an embodiment of the present invention.

FIG. 5a shows a table of information obtained by parsing received highlight meta information.

In this embodiment, the number of segments (i.e., scenes) to be reproduced from among all segments of a program is set to 2 (501). Scene #1 start and end pointers (502) of the first scene “Scene #1” have values of “600” and “1599”, respectively, which indicate the ordinal numbers of corresponding video data frames of the program. Scene #2 start and end pointers (503) of the second scene “Scene #2” have values of “4501” and “6000”. The playback speed (504) of the first scene is set to normal speed (1×), and the playback speed (505) of the second scene is set to triple speed (3×).

FIG. 5b illustrates how the highlights are reproduced using the highlight information of FIG. 5a according to the embodiment of the present invention. If the user selects a highlight function to reproduce highlights of a recorded program, the personal video recorder starts reproducing the recorded program from the 600th frame at normal speed (1×). After reproducing the 1559th frame of the recorded program, the personal video recorder jumps to the 4501st frame and reproduces the recorded program from the 4501st frame at triple speed (3×). The triple speed playback is continued until the reproduction of the 6000th frame is completed. The highlight function is terminated upon completion of the reproduction of the 6000th frame.

The information provider may optionally determine the configuration of highlight scenes and play modes of the scenes to represent the program in their own ways. That is, there is no limitation on the order in which the scenes are arranged in the highlight information and on the total number of highlight scenes. Specifically, highlights may be constituted to display the same scene repeatedly in different play modes.

For example, highlight information including consecutive fields indicative of the same scene with different play modes set thereto is transmitted to display the same scene repeatedly in different playback speeds. Further, the highlight information may be embodied such that the order of highlight scenes differs from the order of the original program scenes. Furthermore, as circumstances permit, the highlight information of a program may be embodied such that the number of highlight scenes is larger than the total number of scenes of the program.

For the same program, there may be various combinations of highlights according to different selections of scenes and various play modes according to the genre of the program and content characteristics thereof. Accordingly, the broadcast station and the third-party service provider may provide multiple sets of highlights for the same program. To accomplish this, the personal video recorder must be capable of receiving and storing the multiple sets of highlights for the same program. In this case, the user can view the program after selecting one of the multiple sets of highlights for the program according to the user's taste.

In addition, the highlight information of a program can be managed independently of the program, for example, so that the highlight information alone can be deleted according to the user's selection.

As apparent from the above description, the present invention provides a private video recorder for implementing a passive highlight function, and a method for providing highlight information to the private video recorder, which have the following features and advantages.

After producing highlights of a broadcast program, which includes key scenes thereof meaningful in terms of content and in which play modes are set for the key scenes, a broadcast station or a third-party service provider transmits corresponding highlight information in real time or non-real time to the private video recorder so that the recorder can properly and accurately play the highlights of the broadcast program. This provides a method for accurately and effectively generating condensed summary information representative of a recorded broadcast program.

A program producer or a third-party service provider itself produces and transmits metadata required to implement a highlight function, thereby making it easier to implement a highlight function of a previously recorded program.

The problem in the conventional method, which requires very complicated hardware and software to implement the highlight function, is overcome, thereby providing a more improved highlight function to the user and also reducing the personal video recorder price burden on the user.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A personal video recorder for implementing a passive highlight function, the recorder comprising:
a stream demultiplexer for separating a received broadcast stream including highlight information into video, audio, data, and video streams, and transferring the separated streams to corresponding decoder blocks capable of decoding the separated streams;
storage means for storing the received broadcast stream;
a download controller for storing the received broadcast stream in the storage means;
an upload controller for reproducing the broadcast stream stored in the storage means; and
a playback controller for accurately locating and extracting highlight data to be reproduced from the broadcast stream and controlling playback speed of the highlight data using the highlight information stream.

2. The recorder according to claim 1, wherein the download controller stores the broadcast stream with a time stamp added thereto in the storage means.

3. The recorder according to claim 1, wherein the highlight information stream includes a highlight ID code, information of the number of highlight scenes, highlight data location information, and highlight playback mode information.

4. The recorder according to claim 3, wherein the highlight information stream further includes a program ID.

5. The recorder according to claim 1, wherein the data stream includes broadcast schedule information.

6. The recorder according to claim 1, wherein if a program corresponding to the highlight information stream is not present in the storage means, the download controller automatically avoids reception of the highlight information stream or automatically deletes the highlight information stream when the highlight information stream is received.

7. The recorder according to claim 1, wherein the storage means employs a hard disk.

8. A method for providing highlight information to a personal video recorder, comprising the steps of:
a) generating highlight information of a broadcast program;
b) combining the highlight information with a broadcast stream to be transmitted; and
c) transmitting the broadcast stream combined with the highlight information.

9. A method for providing highlight information to a personal video recorder, comprising the steps of:
a) generating highlight information of a broadcast program;
b) informing a user of the personal video recorder of presence of the generated highlight information;
c) determining by the user whether to receive the highlight information;
d) combining the highlight information with a broadcast stream to be transmitted; and
e) transmitting the broadcast stream combined with the highlight information.

10. The method according to claim 8 or 9, wherein the highlight information stream includes a highlight ID code, information of the number of highlight scenes, highlight data location information, and highlight playback mode information.

11. The method according to claim 8 or 9, wherein the highlight information stream further includes a program ID.

12. The method according to claim 8 or 9, wherein the broadcast stream includes broadcast schedule information.

13. The method according to claim 8 or 9, wherein the highlight information is produced by a broadcast station providing the broadcast program or a third party.

14. The method according to claim 8 or 9, wherein the highlight information is transmitted by combining the highlight information with the program or another program.
